(19) United States
(12) Patent Application Publication
(10) Pub. No.: US 2018/0162036 A1
(43) Pub. Date: Jun. 14, 2018

(54) SIZING DIE, EXTRUSION MOLDING APPARATUS, AND METHOD OF MANUFACTURING TUBULAR MEMBER USING THE SAME

(71) Applicant: KONICA MINOLTA, INC., Tokyo (JP)

(72) Inventors: Hiroyuki KURIYAMA, Toyokawa-shi (JP); Naotoshi Kawai, Toyokawa-shi (JP)

(21) Appl. No.: 15/830,740

(22) Filed: Dec. 4, 2017

(30) Foreign Application Priority Data
Dec. 9, 2016 (JP) 2016-239548

(51) Int. Cl. B29C 47/90; B29C 47/00; B29C 47/20

(52) U.S. Cl. CPC B29C 47/901; B29L 2031/767; B29C 47/20; B29C 47/0023

(57) ABSTRACT

Provided is a sizing die corresponding to a member installable between an extruder and a take-up machine, including a side surface in contact with an inner or outer surface of a tubular molten resin extruded toward the take-up machine through an annular die by the extruder, and causing the molten resin to flow along the side surface such that a shape of the molten resin matches a shape of the side surface, wherein the side surface includes a first region and a second region in an order of being close to the annular die in a flow direction of the molten resin, and surface roughness of the first region is smaller than surface roughness of the second region.

The entire disclosure of Japanese patent Application No. 2016-239548, filed on Dec. 9, 2016, is incorporated herein by reference in its entirety.

### BACKGROUND

### Technological Field

The present invention relates to an extrusion molding technology, and particularly relates to surface processing of a sizing die.

### Description of the Related Art

In electrophotographic image forming apparatuses such as a laser printer, a copy machine, a facsimile machine and the like, there is a model that uses an endless belt for transferring and fixing a toner image. For example, in an intermediate transfer type image forming unit, the endless belt is used for an image carrier that relays a toner image from a photoreceptor to a sheet. In a belt type fixing unit, the endless belt is used for a rotating body that comes into contact with a sheet to apply heat or pressure or another rotating body that comes into contact with the rotating body to transmit heat. When excessive vibration and impact are applied to a toner image in both transferring and fixing, achievement of high image quality is hindered. Thus, smooth rotation is required for the endless belt used for transferring and fixing. That is, it is desirable to have a belt in which any seam is not present and a peripheral length and a thickness are particularly uniform in a width direction.

In manufacture of a seamless endless belt, a centrifugal molding method or an extrusion molding method is used to mold a base layer. The centrifugal molding method is regarded as advantageous with regard to uniformity of a peripheral length and a thickness. However, from a viewpoint of prevention of environmental pollution, it is desirable to use the extrusion molding method rather than the centrifugal molding method which requires disposal of a large amount of organic solvent.

In the extrusion molding method, a molded article is manufactured from a thermoplastic resin according to the following procedure (for example, see JP 04-255332 A, JP 2003-033963 A, and JP 2012-045804 A). First, a resin pellet is heated and melted in a cylinder. An obtained molten resin is extruded from the cylinder into a mold by a screw and the like. When the molded article corresponds to a tubular member such as an endless belt, an annular die is used as a mold. The annular die includes a flow path having an annular transverse section. The molten resin flows out from the flow path in a tubular shape by being pushed by the flow path. Thereafter, the tubular molten resin comes into contact with a side surface of a sizing die and flows along the side surface. The sizing die is a columnar member, and a shape and a size of the side surface are designed to a desired shape and size of the molded article, respectively. Since the molten resin is cooled and solidified while flowing along the side surface of the sizing die, the shape of the molded article matches the shape of the side surface. When this molded article is pulled out of the sizing die and divided by a desired length, a seamless tubular member, for example, an endless belt is homogeneously mass-produced.

A satin process such as sand blasting is performed on a side surface of a sizing die. An object thereof is to prevent stick-slip from occurring in a molten resin flowing on the side surface. The “stick-slip” refers to self-excited vibration occurring on at least one friction surface when a certain object slides on another object and microscopic fixation and peeling are repeated between friction surfaces of both the objects. When such vibration occurs in the molten resin, a smooth flow thereof is inhibited, and thus there is a risk that a molding error becomes excessive. In particular, when a molded article corresponds to an endless belt for an image forming apparatus, vibrations in peripheral length and thickness in a width direction may become excessive, and these non-uniformities are particularly not preferable for use in transferring and fixing a toner image. In general, as a real contact area between friction surfaces decreases, fixing strength between both the surfaces decreases. Thus, when a friction surface has surface roughness greater than or equal to a certain degree, the stick-slip may be avoided. In extrusion molding, desired surface roughness is assigned to the side surface of the sizing die by the satin process, thereby preventing stick-slip from occurring in the molten resin flowing on the side surface.

In recent years, a printer and a multifunction peripheral (MFP) have been spreading not only in a small office such as a SOHO but also in a general home. Accordingly, further miniaturization, noise reduction, and power saving are required for an electrophotographic model. To respond to such requirements, it is desirable that the endless belt for the image forming apparatus is manufactured to be thinner, lighter, and homogeneous. For example, a technology of further stabilizing the flow of the molten resin on the side surface of the sizing die (for example, see JP 04-255332 A and JP 2012-045804 A), and a technology of further smoothing the surface of the sizing die (for example, see JP 2003-033963 A) have been known as a scheme for extrusion molding intended therefor. However, in the former scheme, a post-treatment for removing the surface roughness of the molded article due to the surface roughness of the sizing die using polishing and the like is indispensable. The latter scheme further requires another scheme for preventing stick-slip due to the molten resin. As described above, in the conventional extrusion molding, it is difficult to further improve both smoothness of the surface of the molded article and uniformity of a shape thereof.

### SUMMARY

An object of the present invention is to solve the above-mentioned problem, and particularly is to provide an extrusion molding apparatus capable of achieving both reduction in the surface roughness of the molded article due to the surface roughness of the sizing die and suppression of a nonuniform shape of the molded article caused by stick-slip.

To achieve at least one of the abovementioned objects, according to an aspect of the present invention, a sizing die reflecting one aspect of the present invention corresponds to a member installable between an extruder and a take-up machine, includes a side surface in contact with an inner or outer surface of a tubular molten resin extruded toward the take-up machine through an annular die by the extruder, and causes the molten resin to flow along the side surface such that a shape of the molten resin matches a shape of the side surface, wherein the side surface includes a first region and a second region in an order of being close to the annular die in a flow direction of the molten resin, and surface roughness of the first region is smaller than surface roughness of the second region.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1A is a perspective view illustrating an appearance of an image forming apparatus according to an embodiment of the present invention, and FIG. 1B is a schematic cross-sectional view taking along b-b line illustrated in FIG. 1A;

FIG. 2A is a schematic perspective view of an intermediate transfer belt illustrated in FIG. 1B, and FIG. 2B is a schematic perspective view of a fixing belt illustrated in FIG. 1B;

FIG. 3A is a perspective view schematically illustrating an appearance of an extrusion molding apparatus according to an embodiment of the present invention, and FIG. 3B is a schematic cross-sectional view taking along b-b line illustrated in FIG. 3A;

FIG. 4A is a graph illustrating a surface roughness distribution of a sizing die in a flow direction of a molten resin, FIG. 4B and FIG. 4C are enlarged cross-sectional views schematically illustrating a surface of a first region of the sizing die and a surface of the molten resin in contact therewith, and FIG. 4D and FIG. 4E are enlarged cross-sectional views schematically illustrating a surface of a second region of the sizing die and a surface of the molten resin in contact therewith;

FIG. 5A is a graph illustrating a viscosity—temperature characteristic curve of the molten resin, and FIG. 5B and FIG. 5C are graphs illustrating a temperature distribution and a viscosity distribution, respectively, in a flow direction occurring in the molten resin flowing on an outer peripheral surface of the sizing die;

FIG. 6 is a flowchart of a manufacturing process of a base layer of the intermediate transfer belt or a fixing belt using the extrusion molding apparatus illustrated in FIG. 3A and FIG. 3B; and

FIG. 7A is a schematic side view of a sizing die according to a modification, and FIG. 7B is a graph illustrating a surface roughness distribution of the sizing die in the flow direction of the molten resin.

### DETAILED DESCRIPTION OF EMBODIMENTS

Hereinafter, one or more embodiments of the present invention will be described with reference to the drawings. However, the scope of the invention is not limited to the disclosed embodiments.

### Outline of Image Forming Apparatus

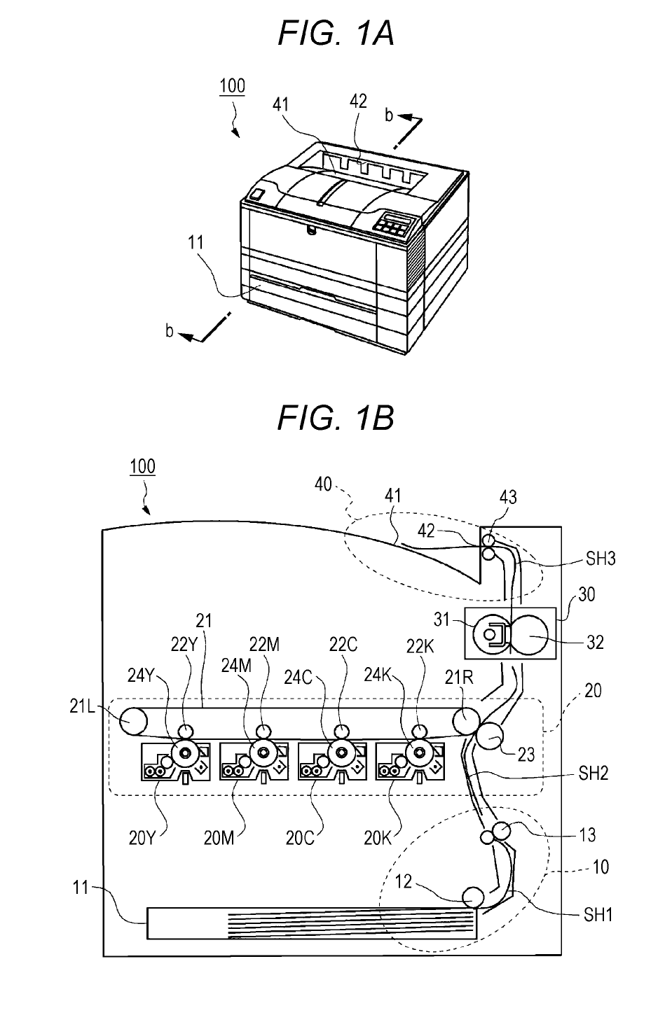

FIG. 1A is a perspective view illustrating an appearance of an image forming apparatus 100 according to an embodiment of the present invention. The image forming apparatus 100 corresponds to a printer. A paper discharge tray 41 is provided on an upper surface of a housing to accommodate a sheet discharged from an open discharge outlet 42 in an inner part. A paper feed cassette 11 is attached to a bottom of the printer 100 such that the paper feed cassette 11 may be pulled out.

FIG. 1B is a schematic cross-sectional view of the printer 100 taking along b-b line illustrated in FIG. 1A. The printer 100 corresponds to a color compatible electrophotographic type, and includes a feeding unit 10, an image forming unit 20, a fixing unit 30, and a paper discharge unit 40. The feeding unit 10 separates sheets SH1 one by one from the paper feed cassette 11 using a pickup roller 12, and sends the sheets to the image forming unit 20 using a timing roller 13. A “sheet” refers to a thin-film or thin plate-like material, article, or printed matter made of paper or resin. For example, the image forming unit 20 corresponds to a printing engine based on an intermediate transfer system, and rotates an intermediate transfer belt 21 (counterclockwise in FIG. 1B) bridged between a driven pulley 21L and a driving pulley 21R to cause four photoreceptor units 20Y, 20M, 20C, and 20K in a tandem arrangement to process a surface thereof. First, the respective units 20Y, . . . , 20K form monochromatic toner images on surfaces of built-in photoreceptor drums 24Y, 24M, 24C, and 24K. A color thereof corresponds to one of yellow (Y), magenta (M), cyan (C), and black (K), and is different for each of the units 20Y, . . . , 20K. Subsequently, these units 20Y, . . . , 20K transfer the monochromatic toner images from the photoreceptor drums 24Y, . . . , 24K to the same surface portion of the intermediate transfer belt 21 passing through nips between the photoreceptor drums 24Y, . . . , 24K and primary transfer rollers 22Y, 22M, 22C, and 22K (primary transfer). In this way, the four monochromatic toner images are superimposed on the surface portion, and one color toner image is formed. A sheet SH2 is fed from the timing roller 13 to a nip between the driving pulley 21R and a secondary transfer roller 23 at a timing at which the color toner image passes through the nip. In this way, at the nip, the color toner image is transferred from the intermediate transfer belt 21 to the sheet SH2 (secondary transfer). The fixing unit 30 feeds a sheet SH3 sent from the image forming unit 20 to a nip between a fixing belt 31 and a pressure roller 32. In this instance, the fixing belt 31 heats a surface of the sheet SH3, and the pressure roller 32 presses the same surface against the fixing belt 31. The toner image is fixed on the surface of the sheet SH3 by heat from the fixing belt 31 and pressure from the pressure roller 32. The paper discharge unit 40 delivers the sheet SH3 on which the toner image is fixed from an upper portion of the fixing unit 30 to the outside of the discharge outlet 42 using a paper discharge roller 43 disposed inside the discharge outlet 42, and places the sheet SH3 on the paper discharge tray 41.

### Endless Belt Used in Image Forming Apparatus

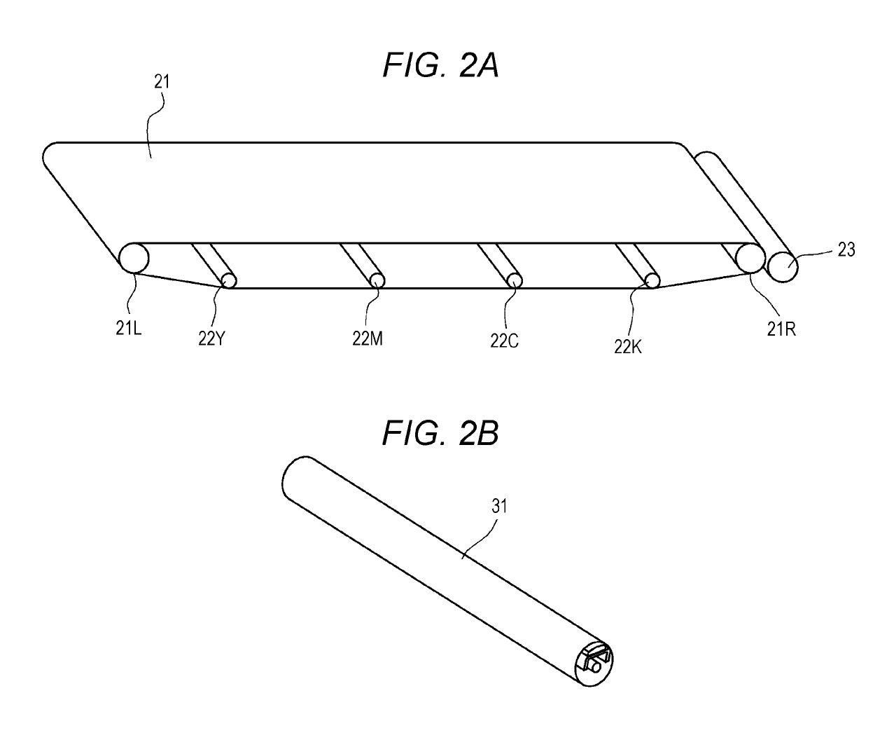

FIG. 2A is a schematic perspective view of the intermediate transfer belt 21 illustrated in FIG. 1B. For example, the intermediate transfer belt 21 is an endless belt having a width of several hundred mm, a peripheral length of several tens mm to several hundred mm, and a thickness of several hundred μm to several mm. In particular, when the intermediate transfer belt 21 is removed from the pulleys 21L and 21R and the primary transfer rollers 22Y, . . . , 22K, the intermediate transfer belt 21 has a thick and short tubular shape whose diameter and height are similar to each other. A base layer of the intermediate transfer belt 21 is manufactured by extrusion molding from a resin having high heat resistance and mechanical strength such as thermoplastic polyimide (PI), polyphenylene sulfide (PPS) and the like. A conductive additive such as carbon is kneaded in the resin, and an electric resistance value of the intermediate transfer belt 21 is adjusted according to an amount thereof. As a result, an appropriate amount of current flows through the intermediate transfer belt 21 depending on the voltage between the photoreceptor drums 24Y, . . . , 24K and the primary transfer rollers 22Y, 22M, 22C, and 22K in the primary transfer and depending on the voltage between the driving pulley 21R and the secondary transfer roller 23 in the secondary transfer. That is, since the toner moves without excess or deficiency in both the primary transfer and the secondary transfer, high image quality of the toner image is maintained.

A toner image is transferred from each of the photoreceptor drums 24Y, . . . , 24K onto a surface of the intermediate transfer belt 21. Therefore, high smoothness of the belt surface is necessary for high image quality of the toner image. In addition, the toner image on the surface of the intermediate transfer belt 21 needs to be transferred to a correct position on a surface of the sheet SH2 while the sheet SH2 passes through the nip between the driving pulley 21R and the secondary transfer roller 23. Further, in color printing, the four photoreceptor units 20Y, . . . , 20K need to accurately superimpose four-color toner images at the same position on the surface of the intermediate transfer belt 21. High homogeneity of the belt, in particular, high uniformity of the peripheral length and the thickness in the width direction are required to accurately control rotation of the intermediate transfer belt 21 in this manner.

FIG. 2B is a schematic perspective view of the fixing belt 31 illustrated in FIG. 1B. For example, the fixing belt 31 is an elongated circular tube-shaped endless belt having a length (width) of several hundred mm, a diameter of several mm to several tens mm, and a thickness of several hundred μm to several mm. A base layer of the fixing belt 31 is manufactured by extrusion molding from a resin having high heat resistance and mechanical strength such as thermoplastic PI, PPS and the like. In particular, high rigidity of the base layer maintains the fixing belt 31 in a circular tube shape. The fixing belt 31 is a non-tension belt (free belt). That is, the fixing belt 31 is not extended around a rotating body such as a pulley. The fixing belt 31 is supported to be rotatable around a central axis thereof while sliding an inner peripheral surface of the base layer along a surface of a pressing pad 311 disposed inside the base layer by the pressing pad 311 and a steel material 312 holding the pressing pad 311. Although not illustrated in FIG. 2A, the fixing belt 31 includes an elastic layer and a mold release layer on an outside of the base layer. The elastic layer is a highly elastic heat-resistant resin film such as silicone rubber covering the outside of the base layer, and the mold release layer is a fluororesin film such as polytetrafluoroethylene (PFA) covering the outside of the elastic layer. For example, these two layers are formed by overlaying and applying a resin and a fluororesin onto an outer peripheral surface of a tubular extrusion-molded article included in the base layer. At a portion of the fixing belt 31 at which the inner peripheral surface comes into contact with the pressing pad 311, the outer peripheral surface on the rear side comes into contact with an outer peripheral surface of the pressure roller 32 to form a nip. The fixing belt 31 transmits heat received from a halogen heater 313 disposed inside the base layer to the sheet SH2 passing through this nip. In this instance, an outer peripheral surface of the fixing belt 31 is deformed to conform to fine irregularities on the surface of the sheet SH2 due to softness of the elastic layer. In this way, heat is uniformly transmitted to the toner image on the surface of the sheet SH2, and thus gloss is made uniform. At an outlet of this nip, when the fixing belt 31 peels off from the surface of the sheet SH2, a phenomenon (offset) in which the toner is transferred from the surface of the sheet SH2 to the fixing belt 31 is prevented by the mold release layer.

In this way, the fixing belt 31 heats the surface of the sheet SH2 to fix the toner image on the surface. Therefore, since uniformity of heat applied to the entire image is important for high image quality of the toner image, the fixing belt 31 needs to bring the surface into close contact with the sheet SH2 and uniformly store heat in a close contact portion thereof. Therefore, in addition to high smoothness of the belt surface, high homogeneity of the belt, in particular, high uniformity of the peripheral length and the thickness in the width direction are required.

### Structure of Extrusion Molding Apparatus

Both the intermediate transfer belt 21 and the fixing belt 31 are required to have high smoothness of the belt surface and high homogeneity of the belt. To satisfy this requirement, an extrusion molding apparatus described below is used for extrusion molding of the base layers of the belts 21 and 31.

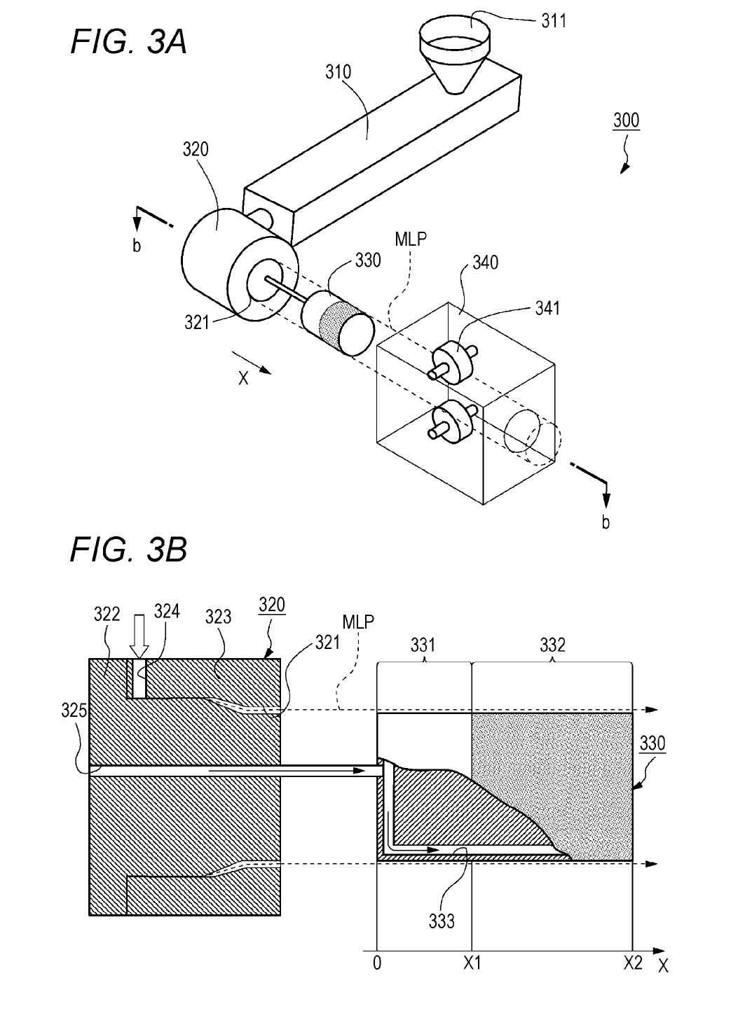

FIG. 3A is a perspective view schematically illustrating an appearance of an extrusion molding apparatus 300 according to an embodiment of the present invention, and FIG. 3B is a schematic cross-sectional view taking along b-b line illustrated in FIG. 3A. The base layer of the intermediate transfer belt 21 illustrated in FIG. 2A and the base layer of the fixing belt 31 illustrated in FIG. 2B are manufactured by the extrusion molding apparatus 300. The extrusion molding apparatus 300 includes an extruder 310, an annular die 320, a sizing die 330, and a take-up machine 340.

The extruder 310 melts the resin and extrudes the melted resin to the annular die 320. Specifically, first, the extruder 310 accommodates a resin pellet into a cylinder 312 through a hopper 311. The resin pellet is a fine particle including a kneaded additive (for example, a conductive additive for adjusting electric resistance) required for a thermoplastic resin (for example, thermoplastic PI or PPS) corresponding to a main raw material. Subsequently, the extruder 310 heats, melts, and liquefies the resin pellet in the cylinder 312. Further, the extruder 310 pushes a liquid molten resin from the cylinder 312 toward the annular die 320 using a screw and the like (not illustrated).

For example, the annular die 320 is a columnar member made of metal or ceramic and includes a flow path 321 therein. For example, the flow path 321 is formed by a gap between a columnar shaft member 322 and a cylindrical member 323 coaxially surrounding the shaft member 322. In particular, a transverse section (a cross section perpendicular to an axial direction) has an annular shape coaxially with both the members 322 and 323. The flow path 321 is connected to the cylinder 312 of the extruder 310 through a hole 324 on a side of the annular die 320. The molten resin extruded from the extruder 310 flows from the hole 324 into the flow path 321, uniformly spreads throughout the flow path 321, and then flows out therefrom. As a result, the molten resin has a circular tube shape coaxial with the annular die 320 and extends in the axial direction thereof as indicated by broken lines MLP in FIGS. 3A and 3B.

For example, the sizing die 330 is a columnar member made of metal or ceramic, and is disposed coaxially with the annular die 320 on an extension line in a direction in which the molten resin MLP flows out from the flow path 321 of the annular die 320 (a positive direction of an X axis in the figure). An outer diameter of the sizing die 330 is equal to or smaller than an inner diameter of the flow path 321 of the annular die 320, and is particularly equal to an inner diameter of the tubular member corresponding to a molded article, for example, the base layer of the intermediate transfer belt 21 or the base layer of the fixing belt 31. Therefore, the molten resin MLP flowing out from the flow path 321 of the annular die 320 flows in the axial direction (the positive direction of the X axis) along an outer peripheral surface of the sizing die 330 while an entire circumference of an inner peripheral surface of the circular tube shape is brought into contact with the outer peripheral surface of the sizing die 330.

The sizing die 330 further has a structure for cooling the molten resin MLP flowing on the outer peripheral surface. Specifically, for example, a circulation path 333 is provided inside the outer peripheral surface of the sizing die 330, and is connected to a supply path 325 penetrating the annular die 320 in the axial direction. A refrigerant such as water, oil, air and the like enters the circulation path 333 through the supply path 325. The circulation path 333 circulates the refrigerant such that the refrigerant spreads over the entire outer peripheral surface. Since the refrigerant absorbs heat while the molten resin MLP flows on the outer peripheral surface of the sizing die 330, the molten resin MLP is cooled and solidified. As a result, the circular tube shape of the molten resin MLP, particularly the shape of the inner peripheral surface thereof matches a shape of an outer surface of the sizing die 330.

The take-up machine 340 receives the circular tube-shaped resin MLP passing through the sizing die 330. Specifically, for example, the take-up machine 340 includes a pair of rollers 341 disposed on an extension line in a direction in which the circular tube-shaped resin MLP extends from the sizing die 330 (the positive direction of the X axis in the figure). Both the rollers 341 rotate while interposing the resin MLP between outer peripheral surfaces thereof. In this way, the resin MLP is drawn from the sizing die 330. The resin MLP is divided by a desired length, for example, by the width of the intermediate transfer belt 21 or the fixing belt 31. This divided portion is used as a base layer of one endless belt having no seam, for example, the intermediate transfer belt 21 or the fixing belt 31.

### Surface Roughness Distribution of Sizing Die

When the base layer of the intermediate transfer belt 21 or the fixing belt 31 is formed using the extrusion molding apparatus 300, the surface roughness of the sizing die 330 is particularly important. As the surface roughness decreases, the smoothness of the belt surface increases. However, since the stick-slip is liable to occur, it is difficult to maintain high uniformities of the peripheral length and the thickness of the belt in the width direction.

Conversely, as the surface roughness of the sizing die 330 increases, the stick-slip is less likely to occur. Thus, variations in peripheral length and thickness of the belt are suppressed. However, the surface roughness of the belt remains at a similar size to a size of the surface roughness of the sizing die 330. The sizing die 330 has a structure below in the extrusion molding apparatus 300 to achieve both reduction of the surface roughness of the belt and suppression of an inhomogeneous shape thereof.

The outer peripheral surface of the sizing die 330 includes a first region 331 and a second region 332 in an order of being close to the annular die 320 (having a small coordinate X in the figure) in a flow direction of the molten resin MLP (X axis direction in the figure). Both the regions 331 and 332 have annular shapes. The surface roughness differs between these regions 331 and 332. In particular, the first region 331 is processed to have smaller surface roughness than that of the second region 332.

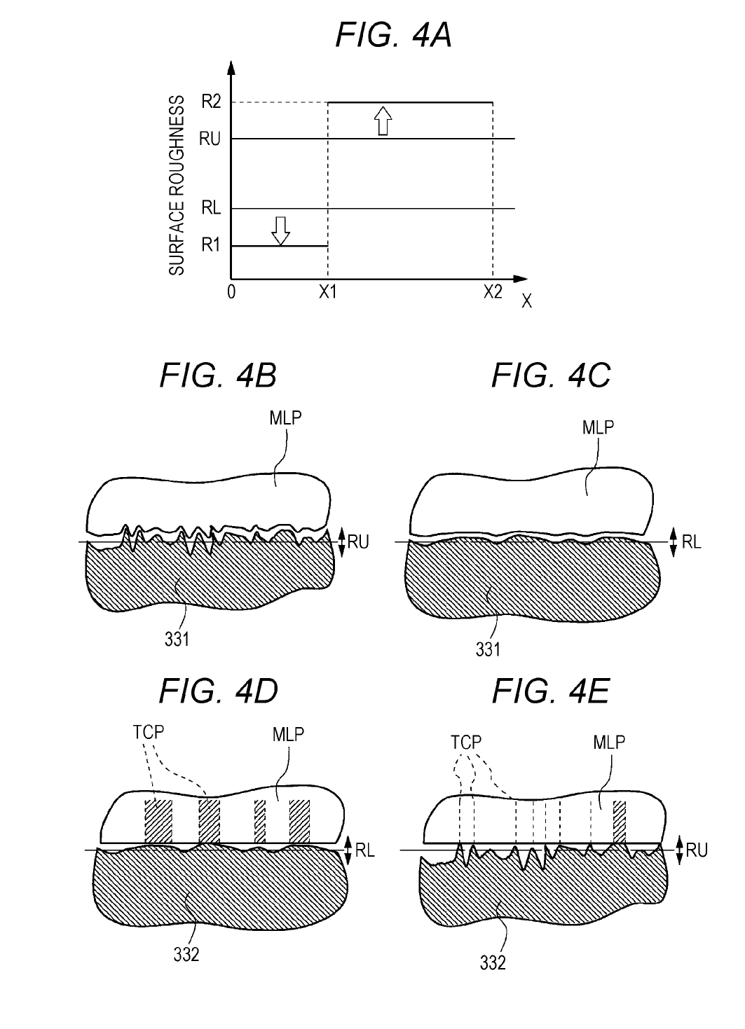

FIG. 4A is a graph illustrating a surface roughness distribution of the sizing die 330 in the flow direction of the molten resin MLP. A horizontal axis of this graph represents a coordinate X in the flow direction of the molten resin MLP. An origin X=0 indicates a position closest to the annular die 320 on the outer peripheral surface of the sizing die 330.

The first region 331 extends from an edge of the sizing die 330 positioned at the origin X=0 in the flow direction of the molten resin MLP (the positive direction of the X axis). Surface roughness of the first region 331 is set to a value R1 lower than a target value RL (for example, several hundred nm) for the molded article. This setting is accomplished by performing mirror processing on the first region 331. Specifically, for example, the first region 331 is covered with plating.

The second region 332 extends continuously from the first region 331 in the flow direction of the molten resin MLP (the positive direction of the X axis) up to an opposite side edge X=X2 of the sizing die 330. Surface roughness of the second region 332 is set to a value R2 equal to or larger than a lower limit RU (for example, several tens of μm) at which stick-slip due to the molten resin MLP flowing in the second region 332 may be prevented. This setting is accomplished by performing a satin process such as sand blasting on the second region 332.

### Influence of Surface Roughness of Sizing Die on Molten Resin

The molten resin MLP is cooled and solidified while flowing through the first region 331 and the second region 332 in order. As described above, the surface roughness is small in the order of the first region 331 and the second region 332. In this way, it is possible to keep the surface roughness of the solidified resin MLP below the target value RL and suppress stick-slip due to the resin MLP. A reason therefor is as follows.

### Viscosity—Temperature Characteristic of Molten Resin

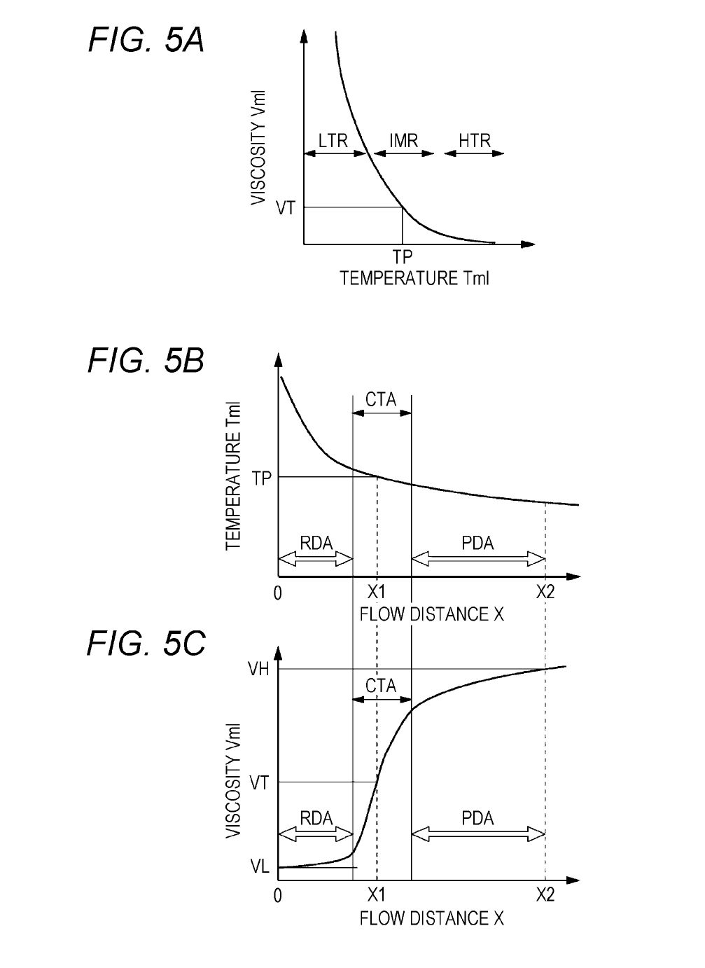

FIG. 5A is a graph illustrating a viscosity-temperature characteristic curve of the molten resin MLP. Although not clearly illustrated in this figure, a vertical axis of the graph represents the viscosity Vml of the molten resin MLP, and a horizontal axis represents the temperature Tml thereof in a linear dimension (linear scale). As indicated by this graph, the viscosity Vml of the molten resin MLP rises exponentially as the temperature Tml decreases. This viscosity-temperature characteristic is qualitatively described as follows. In general, the thermoplastic resin is solid at room temperature and melts and liquefies when the thermoplastic resin is heated and a temperature thereof exceeds a melting point. The molten resin is increased in viscosity as the molten resin is cooled and decreases in temperature, and changes from a liquid state to a rubber state when the temperature falls below a melting point. In the thermoplastic resin, an amorphous resin solidifies (vitrifies) when a temperature drops to a glass transition temperature, and a crystalline resin begins to solidify (crystallize) when a temperature drops to a crystallization temperature. Both the resins rapidly rise in viscosity in response to solidification.

### Temperature Distribution of Molten Resin on Sizing Die

FIG. 5B is a graph illustrating a temperature distribution in a flow direction occurring in the molten resin MLP flowing on the outer peripheral surface of the sizing die 330. A vertical axis of this graph represents the temperature Tml of the molten resin MLP, and a horizontal axis represents a coordinate X in the flowing direction of the molten resin MLP similarly to FIG. 4A. An origin X=0 indicates a position closest to the annular die 320 on the outer peripheral surface of the sizing die 330. While the molten resin MLP flows on the outer peripheral surface, the outer peripheral surface continues to absorb heat of the molten resin MLP. Thus, as a flow distance, that is, the coordinate X on the outer peripheral surface increases, the temperature Tml decreases. As a temperature difference between the molten resin MLP and the outer peripheral surface of the sizing die 330 narrows, the amount of heat deprived from the resin MLP to the outer peripheral surface decreases. Therefore, a descent rate of the temperature Tml with respect to the coordinate X, that is, a slope of the graph becomes moderate as the coordinate X increases.

### Viscosity Distribution of Molten Resin on Sizing Die

FIG. 5C is a graph illustrating a viscosity distribution in the flow direction occurring in the molten resin MLP flowing on the outer peripheral surface of the sizing die 330. A vertical axis of this graph represents the viscosity Vml of the molten resin MLP, and a horizontal axis represents a coordinate X in the flowing direction of the molten resin MLP similarly to FIG. 4A. An origin X=0 indicates a position closest to the annular die 320 on the outer peripheral surface of the sizing die 330. Referring to the molten resin MLP, the temperature Tml decreases as the coordinate X increases as illustrated in FIG. 5B, and the viscosity Vml increases as the temperature Tml decreases as illustrated in FIG. 5A. Therefore, as illustrated in FIG. 5C, the viscosity Vml increases as the coordinate X increases.

As illustrated in FIG. 5B, at an edge on a side close to the annular die 320 and the vicinity thereof (hereinafter referred to as a “first end portion”) with respect to a central portion CTA in the axial direction on the outer peripheral surface of the sizing die 330, that is, the origin X=0 and the vicinity RDA thereof, the temperature Tml is high, and the descent rate of the temperature Tml with respect to the coordinate X is high when compared to an edge on a side close to the take-up machine 340 and the vicinity thereof (hereinafter referred to as a “second end portion”), that is, the coordinate X=X2 and the vicinity PDA thereof. Meanwhile, as illustrated in FIG. 5A, at a high temperature side HTR with respect to an intermediate region IMR in a range of the temperature Tml, the viscosity Vml is remarkably lower than that at a low temperature side LTR, and a rate of change of the viscosity Vml with respect to the temperature Tml is remarkably low. Therefore, as illustrated in FIG. 5C, the viscosity Vml is maintained approximately equal to a lowest value VL in the first end portion RDA of the outer peripheral surface of the sizing die 330, and gradually rises toward a highest value VH in the second end portion PDA. The lowest value VL is negligibly low with respect to the highest value VH. In the central portion CTA of the outer peripheral surface, the temperature Tml belongs to the intermediate region IMR, and the viscosity Vml rises from the vicinity of the lowest value VL to the vicinity of the highest value VH. Therefore, in general, the central portion CTA has a higher rate of increase in the viscosity Vml with respect to the coordinate X than any of the first end portion RDA and the second end portion PDA, that is, the slope of the viscosity distribution curve is large. In particular, a point at which this increase rate is a maximum, that is, an inflection point IFP of the viscosity distribution curve appears in the central portion CTA.

When the central portion CTA is sufficiently short when compared to the entire length in the axial direction (X axis direction) of the sizing die 330, the viscosity Vml of the molten resin MLP may be regarded as changing in a binary manner from the lowest value VL to the highest value VH using the inflection point IFP as a boundary. A boundary between the first region 331 and the second region 332 is set at the coordinate X=X1 of the inflection point IFP.

### Significance of Surface Roughness of First Region

FIG. 4B is an enlarged cross-sectional view schematically illustrating a surface of the first region 331 and the surface of the molten resin MLP in contact therewith. In particular, this figure illustrates a case in which surface roughness of the first region 331 is equal to the lower limit RU at which stick-slip due to the molten resin MLP may be prevented. The first region 331 is located on a side of the annular die 320 with respect to the coordinate X=X1 of the inflection point IFP of the viscosity distribution curve. In the region, the viscosity Vml of the molten resin MLP is kept below a value VT at the inflection point IFP, particularly at a value substantially equal to the lowest value VL. Therefore, when irregularity present on the surface of the first region 331 is a height difference of the lower limit RU as illustrated in FIG. 4B, for example, a height difference of several tens of μm, the surface of the molten resin MLP is deformed faithfully according to the irregularity. The viscosity Vml of the molten resin MLP rapidly increases in the vicinity of the boundary X=X1 between the first region 331 and the second region 332. Thus, in a portion of the molten resin MLP beyond the boundary X=X1, the surface roughness remains substantially the same as the lower limit RU, and solidification occurs while the target value RL for the molded article is excessively exceeded.

FIG. 4C is an enlarged cross-sectional view schematically illustrating the surface of the first region 331 and the surface of the molten resin MLP in contact therewith and particularly illustrates a case in which the surface roughness of the first region 331 is smaller than the target value RL for the molded article. To prevent excessive surface roughness from remaining on the solidified resin MLP, the first region 331 is subjected to mirror processing and covered with, for example, plating. In this way, only a small height difference illustrated in FIG. 4C, for example, minute irregularity of several hundred nm at most is present on the surface of the first region 331. Therefore, even when the surface of the molten resin MLP is deformed faithfully according to the irregularity, the surface roughness of the molten resin MLP solidified beyond the boundary X=X1 between the first region 331 and the second region 332 remains at or below the target value RL for the molded article.

### Significance of Surface Roughness of Second Region

FIG. 4D is an enlarged cross-sectional view schematically illustrating the surface of the second region 332 and the surface of the molten resin MLP in contact therewith and particularly illustrates a case in which the surface roughness of the second region 332 is smaller than the target value RL for the molded article. The second region 332 is located on a side of the take-up machine 340 with respect to the coordinate X=X1 of the inflection point IFP of the viscosity distribution curve. In the region, the viscosity Vml of the molten resin MLP is higher than the value VT at the inflection point IFP, particularly close to the highest value VH. Therefore, regardless of the surface roughness of the second region 332, the surface roughness of the molten resin MLP is maintained at or below the target value RL for the molded article. Even when the second region 332 is subjected to mirror processing similarly to the first region 331, and only a small height difference illustrated in FIG. 4D, for example, minute irregularity of several hundred nm at most is present on the surface, a surface portion TCP of the molten resin MLP in real contact with the surface has a large area. When a ratio of a real contact area to an apparent contact area between the second region 332 and the surface of the molten resin MLP is sufficiently high, the molten resin MLP is likely to adhere to the second region 332, and thus a risk of occurrence of stick-slip is high. In the second region 332, the molten resin MLP has not completely solidified. When stick-slip occurs, vibration propagating in the flow direction in response to the stick-slip may cause a cross-sectional shape or thickness of the molten resin MLP to fluctuate excessively in the flow direction. When the molten resin MLP solidifies in this state, excessive variations in peripheral length and thickness in the width direction may remain in the base layers of the belts 21 and 31 corresponding to a molded article.

FIG. 4E is an enlarged cross-sectional view schematically illustrating the surface of the second region 332 and the surface of the molten resin MLP in contact therewith and particularly illustrates a case in which the surface roughness of the second region 332 is greater than or equal to an upper limit RU at which the stick-slip due to the molten resin MLP may be prevented. In the second region 332, the viscosity Vml of the molten resin MLP is sufficiently higher than the value VT at the inflection point IFP. Thus, even when minute irregularity, for example, a height difference of about several tens of μm is present in the surface portion of the sizing die 330, a risk of rough deformation to the same extent as the irregularity is low. As a result, as illustrated in FIG. 4E, the area of the surface portion TCP of the molten resin MLP in real contact with the second region 332 is sufficiently small, that is, the ratio of the real contact area to the apparent contact area is sufficiently low. Therefore, the molten resin MLP does not substantially adhere to the second region 332, and thus the risk of occurrence of stick-slip is sufficiently kept low.

### Flow of Manufacturing Process of Belt Using Extrusion Molding

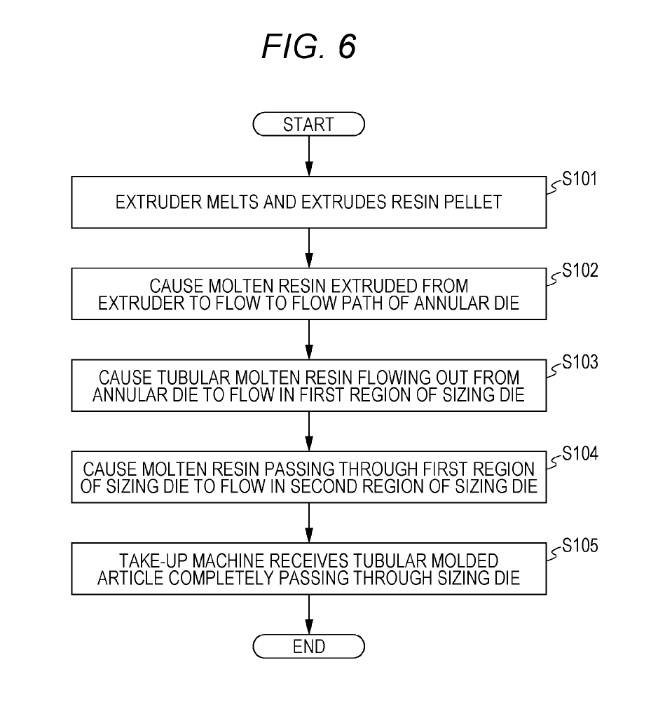

FIG. 6 is a flowchart of a manufacturing process of the base layer of the intermediate transfer belt 21 or the fixing belt 31 using the extrusion molding apparatus 300.

In step S101, the extruder 310 melts the resin pellet and extrudes the melted resin pellet to the annular die 320. Thereafter, the process proceeds to step S102.

In step S102, the annular die 320 causes molten resin extruded from the extruder 310 to flow from the hole 324 on the side to the flow path 321 on the inside. The molten resin MLP uniformly spreads over the entire flow path 321 and then becomes a circular tube shape coaxial with the annular die 320 and flows out in the axial direction thereof. Thereafter, the process proceeds to step S103.

In step S103, the molten resin MLP flowing out from the flow path 321 of the annular die 320 starts to flow on the outer peripheral surface of the sizing die 330. First, the molten resin MLP flows in the axial direction in a state in which the entire circumference of the circular tube-shaped inner peripheral surface comes into contact with the first region 331 of the sizing die 330. Since the temperature Tml of the molten resin MLP belongs to the high temperature side HTR illustrated in FIG. 5A, the viscosity Vml of the molten resin MLP is kept at a remarkably low value. Accordingly, the surface of the molten resin MLP is deformed faithfully according to the minute irregularity present on the surface of the first region 331. The molten resin MLP is cooled by the sizing die 330 while flowing through the first region 331. Thus, the temperature Tml decreases and the temperature eventually shifts from the high temperature side HTR to the intermediate region IMR illustrated in FIG. 5A. Accordingly, the viscosity Vml of the molten resin MLP rapidly increases, and thus the molten resin MLP becomes rubbery. However, since the first region 331 is covered with plating and the surface roughness thereof is adjusted to the value R1 smaller than the target value RL for the molded article, the surface roughness of the molten resin MLP stays below the target value RL. Thereafter, the process proceeds to step S104.

In step S104, the molten resin MLP passes through the first region 331 and starts to flow in the second region 332. Since the temperature Tml of the molten resin MLP shifts from the intermediate region IMR to the low temperature side LTR illustrated in FIG. 5A, the viscosity Vml of the molten resin MLP rises beyond the value VT at the inflection point IFP of the viscosity distribution curve. Therefore, the molten resin MLP maintains the surface roughness thereof at or below the target value RL for the molded article regardless of the surface roughness of the second region 332. Since the second region 332 is subjected to the satin process according to sand blasting, the surface roughness thereof is set to a high value greater than or equal to the lower limit RU at which stick-slip due to the molten resin MLP may be prevented. As a result, in the second region 332, since the ratio of the real contact area to the apparent contact area with the molten resin MLP is sufficiently low, the risk that stick-slip may occur in the molten resin MLP is sufficiently kept low. Thereafter, the process proceeds to step S105.

In step S105, as a result of cooling by the sizing die 330, the molten resin MLP solidifies and the circular tube shape thereof matches the shape of the outer surface of the sizing die 330. The take-up machine 340 receives the resin MLP passing through the sizing die 330. When the resin MLP is divided by the width of the intermediate transfer belt 21 or the fixing belt 31, the base layer of the belt 21 or 31 is completed. Thereafter, the process ends.

### Advantages of Embodiments

In the MFP 100 according to the embodiment of the present invention, as described above, the intermediate transfer belt 21 or the fixing belt 31 includes the base layer manufactured using extrusion molding. The sizing die 330 used in this extrusion molding includes the first region 331 and the second region 332 on the outer surface in the order of being close to the annular die 320. The first region 331 is processed to have a smaller surface roughness value than that of the second region 332 (R1<R2). The tubular molten resin MLP extruded from the annular die 320 by the extruder 310 flows in the order of the first region 331 and the second region 332, is cooled and solidified during the flow, and the tubular shape thereof matches the shape of the outer surface of the sizing die 330. In the molten resin MLP, a portion at which the temperature Tml is sufficiently high and the viscosity Vml decreases as being deformed according to the irregularity on the outer peripheral surface of the sizing die 330 is located in the first region 331, and a portion at which the temperature Tml is sufficiently low and the viscosity Vml is high when the shape of the surface can be maintained irrespective of the irregularity on the outer peripheral surface of the sizing die 330 is located in the second region 332. In the first region 331, for example, the surface roughness thereof is adjusted to the value R1 smaller than the target value RL for the molded article through mirror processing, and thus the surface roughness of the resin MLP solidified through the first region 331 is sufficiently small. In the second region, for example, the surface roughness thereof is adjusted to the value R2 equal to or larger than the lower limit RU at which stick-slip due to the molten resin MLP may be prevented through the satin process, and thus stick-slip substantially does not occur in the molten resin MLP flowing in the second region 332. As a result, the resin MLP completely solidified after passing through the second region 332, that is, the base layers of the belts 21 and 31 corresponding to molded articles, has sufficiently high peripheral length and thickness uniformity in the width direction. In this way, the extrusion molding apparatus 300 according to the embodiment of the present invention may achieve both reduction in the surface roughness of the molded article due to the surface roughness of the sizing die 330 and suppression of an inhomogeneous shape of the molded article due to stick-slip.

### Modifications

(A) The image forming apparatus 100 according to the embodiment of the present invention corresponds to an electrophotographic color printer. Besides, the image forming apparatus according to the embodiment of the present invention may correspond to a single function machine such as a monochrome printer, a copy machine, a facsimile machine and the like or an MFP.

(B) In a free belt nip structure of the fixing unit 30 illustrated in FIG. 1B, a heating member corresponds to the belt 31 and a pressing member corresponds to the roller 32. Conversely, the heating member may correspond to a roller and the pressing member may correspond to a belt. Further, instead of the free belt 31, the fixing belt may correspond to a belt stretched between the pressing pad 311 and another pulley.

(C) In the extrusion molding apparatus 300 illustrated in FIG. 3A and FIG. 3B, the sizing die 330 corresponds to a columnar member, and the outer peripheral surface is brought into contact with the inner surface of the tubular molten resin MLP to cause the molten resin MLP to flow along the outer peripheral surface. In this way, the molded article is shaped into the circular tube shape. In particular, the inner peripheral surface thereof corresponds to the same shape of that of the outer peripheral surface of the sizing die 330. Besides, the sizing die may correspond to a cylindrical member, and the inner peripheral surface may be brought into contact with the outer surface of the tubular molten resin to cause the molten resin to flow along the inner peripheral surface. In this case, the molded article is shaped into the columnar shape. In particular, the outer peripheral surface thereof corresponds to the same shape of that of the inner peripheral surface of the sizing die. In addition, the transverse section of the sizing die may have a shape other than a circle.

(D) The take-up machine 340 illustrated in FIG. 3A and FIG. 3B draws the resin MLP completely passing through the sizing die 330 from the sizing die 330 by interposing the resin MLP between the pair of rollers 341. Alternatively, the take-up machine may use an endless track in place of the rollers 341. In addition, when the molded article has a tubular shape, a take-up roller or an endless track may be disposed inside the molded article.

(E) Plating is performed as mirror processing on the first region 331 of the sizing die 330 illustrated in FIG. 3A and FIG. 3B. Besides, the mirror processing may correspond to buff polishing, electrolytic polishing, or chemical polishing. Sand blasting is performed as a satin process on the second region 332 of the sizing die 330 illustrated in FIG. 3A and FIG. 3B. Besides, the satin process may correspond to polishing using a wire brush or dispersive plating.

(F) The first region 331 of the sizing die 330 illustrated in FIG. 3A and FIG. 3B may include a mold release layer such as nickel plating, a fluororesin film and the like on a surface layer. Since the mold release layer prevents sticking of the molten resin MLP, even though the surface roughness of the first region 331 is considerably lower than the lower limit RU at which stick-slip may be prevented, the risk that stick-slip may occur in the molten resin MLP is further reduced.

(G) In the sizing die 330 illustrated in FIG. 3A and FIG. 3B, the second region 332 is continuous with the first region 331 since the central portion CTA (that is, a portion at which the temperature Tml of the flowing molten resin MLP belongs to the intermediate region IMR of the viscosity - temperature characteristic curve in the outer peripheral surface of the sizing die 330) is sufficiently short when compared to the entire length in the axial direction of the sizing die 330, and thus the viscosity Vml of the molten resin MLP may be regarded as changing in a binary manner using the inflection point IFP of the characteristic curve as a boundary. Besides, the sizing die may further include a region in which the surface roughness gradually changes in the flow direction of the molten resin MLP between the first region and the second region.

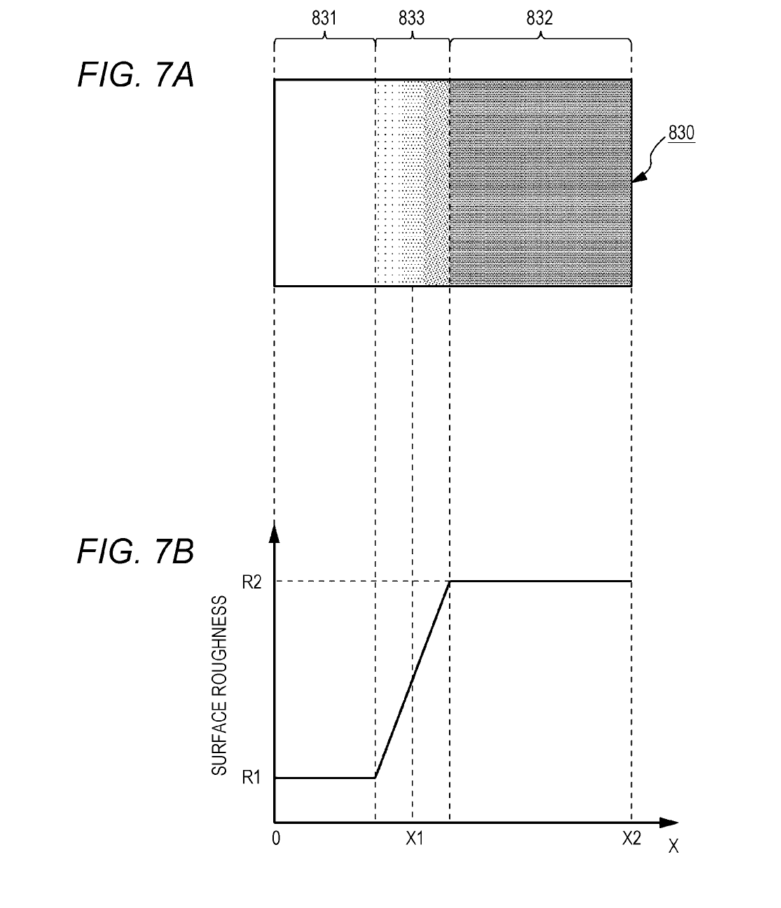

FIG. 7A is a schematic side view of a sizing die 830 according to a modification, and FIG. 7B is a graph illustrating a surface roughness distribution of the sizing die 830 in the flow direction of the molten resin MLP. A horizontal axis of this graph represents a coordinate X in the flow direction of the molten resin MLP. An origin X=0 indicates a position closest to the annular die 320 on an outer peripheral surface of the sizing die 830. A first region 831 is an area in which surface roughness is adjusted to a value R1 lower than the target value for the molded article. This region 831 corresponds to the first end portion RDA illustrated in FIG. 5C, that is, a range in which the temperature Tml of the flowing molten resin belongs to the high temperature side HTR and the viscosity Vml is maintained approximately equal to the lowest value VL. A second region 832 is a region in which surface roughness is adjusted to a value R2 greater than or equal to a lower limit at which stick-slip due to the flowing molten resin may be prevented. This region 832 corresponds to the second end portion PDA illustrated in FIG. 5C, that is, a range in which the temperature Tml of the flowing molten resin belongs to the low temperature side LTR and the viscosity Vml gradually rises toward the highest value VH. A region 833 interposed between the first region 831 and the second region 832 is a region in which the surface roughness continuously changes from the value R1 of the first region 831 to the value R2 of the second region 832. This region 833 corresponds to the central portion CTA illustrated in FIG. 5C, that is, a range in which the temperature Tml of the flowing molten resin belongs to the intermediate region IMR and the viscosity Vml rises from the vicinity of the lowest value VL to the vicinity of the highest value VH. In particular, the coordinate X=X1 of the inflection point IFP of the viscosity distribution curve of the molten resin illustrated in FIG. 5C is located in this region 833.

In addition to a continuous change illustrated in FIG. 7B, surface roughness of this region 833 may change stepwise. For example, both changes can be realized by repeating buff polishing, electrolytic polishing, or chemical polishing in various degrees. In this region 833, the surface roughness increases in accordance with the increase in the flow distance of the molten resin, that is, the viscosity Vml associated with the increase in the coordinate X. In this way, even when the ratio of the length of the central portion CTA to the total length in the axial direction of the sizing die 330 is high, it is possible to achieve both reduction in the surface roughness of the molded article due to the surface roughness of the sizing die 830 and suppression of an inhomogeneous shape of the molded article due to stick-slip.

The present invention relates to a sizing die mounted on an extrusion molding apparatus, and a first region located on an annular die side on a side surface thereof is processed to have smaller surface roughness than that of a second region located on a take-up machine side as described above. In this way, the present invention is clearly industrially applicable.

Although embodiments of the present invention have been described and illustrated in detail, the disclosed embodiments are made for purposes of illustration and example only and not limitation. The scope of the present invention should be interpreted by terms of the appended claims.

What is claimed is:

1. A sizing die corresponding to a member installable between an extruder and a take-up machine, including a side surface in contact with an inner or outer surface of a tubular molten resin extruded toward the take-up machine through an annular die by the extruder, and causing the molten resin to flow along the side surface such that a shape of the molten resin matches a shape of the side surface,
wherein the side surface includes a first region and a second region in an order of being close to the annular die in a flow direction of the molten resin, and
surface roughness of the first region is smaller than surface roughness of the second region.

2. The sizing die according to claim 1, wherein
the surface roughness of the first region is less than or equal to a target value for a molded article, and
the surface roughness of the second region is greater than or equal to a value allowing prevention of an occurrence of stick-slip in the molten resin flowing in the second region.

3. The sizing die according to claim 1, wherein the first region corresponds to a portion of the side surface subjected to mirror processing.

4. The sizing die according to claim 3, wherein the mirror processing on the first region corresponds to plating.

5. The sizing die according to claim 1, wherein the first region includes a mold release layer in a surface layer.

6. The sizing die according to claim 1, wherein a viscosity distribution in the flow direction indicated by the molten resin flowing on the side surface includes an inflection point, the first region is located on a side of the annular die with respect to a position of the inflection point, and the second region is located on a side of the take-up machine.

7. The sizing die according to claim 1, wherein the first region and the second region are continuous in the flow direction of the molten resin.

8. The sizing die according to claim 1, wherein the side surface further includes a region between the first region and the second region in which surface roughness gradually changes in the flow direction of the molten resin.

9. The sizing die according to claim 1, further comprising a structure for cooling the molten resin flowing on the side surface by circulating a refrigerant.

10. The sizing die according to claim 1, wherein the sizing die has a columnar shape and the side surface comes into contact with the inner surface of the tubular molten resin.

11. The sizing die according to claim 1, wherein the sizing die has a tubular shape and the side surface comes into contact with the outer surface of the tubular molten resin.

12. An extrusion molding apparatus comprising:
an extruder that melts and extrudes a resin;
an annular die that includes a flow path having an annular transverse section and causes a molten resin extruded from the extruder to flow through the flow path;
the sizing die according to claim 1 that causes a tubular molten resin flowing out from the flow path of the annular die to flow along a side surface such that a shape of the molten resin matches a shape of the side surface; and
a take-up machine that receives a tubular molded article passing through the sizing die.

13. A method of manufacturing a tubular member, comprising:
melting and extruding a resin by an extruder;
causing a molten resin extruded from the extruder to flow through a flow path having an annular transverse section included in an annular die;
causing a tubular molten resin flowing out from the flow path of the annular die to flow along a side surface of the sizing die according to claim 1, and cooling and solidifying the molten resin during the flowing such that a shape of the molten resin matches a shape of the side surface; and
receiving a tubular molded article passing through the sizing die by a take-up machine.

14. The method of manufacturing a tubular member according to claim 13, wherein the tubular molded article corresponds to an endless belt used for transferring or fixing a toner image in an electrophotographic image forming apparatus.
